(19) United States
(12) Patent Application Publication
(10) Pub. No.: US 2009/0025434 A1
(43) Pub. Date: Jan. 29, 2009

(54) Buckling assembly and casing structure using the same

(75) Inventor: Miao-Hung Ling, Chung-Ho City (TW)

Correspondence Address: RABIN & Berdo, PC, 1101 14TH STREET, NW, SUITE 500, WASHINGTON, DC, 20005, US

(73) Assignee: Cooler Master Co., Ltd., Taipei Hsien (TW)

(21) Appl. No.: 12/149,648

(22) Filed: May 6, 2008

(30) Foreign Application Priority Data
Jul. 27, 2007 (TW) 096212406

(51) Int. Cl. E05B 65/00

(52) U.S. Cl. 70/57

(57) ABSTRACT

A buckling assembly and a casing structure using the same are described. The buckling assembly is used for fixedly locking a buckled member which may be a panel or a casing. The buckling assembly includes a guide rail, a locking seat, and a rotary handle. The guide rail is fixed on an inner side of the casing or the panel. The locking seat is slidably disposed on the guide rail for locking the buckled member. The rotary handle is pivotally affixed to the guide rail and is turned to drive the locking seat move on the guide rail, so as to lock or release the buckled member.

### CROSS-REFERENCE TO RELATED APPLICATIONS

This non-provisional application claims priority under 35 U.S.C. § 119(a) on Patent Application No(s). 096212406 filed in Taiwan, R.O.C. on Jul. 27, 2007 the entire contents of which are hereby incorporated by reference.

### BACKGROUND OF THE INVENTION

1. Field of Invention

The present invention relates to a buckling assembly and a casing structure using the same, in particular, to a buckling assembly that enables a quick attachment or removal of a panel of a casing structure and the casing structure.

2. Related Art

A casing of a host device is used for enclosing and carrying electronic components of a computer, for example, a motherboard, a power supply, a hard disk drive, an optical disk drive, etc. The casing is used to provide a proper protection and support for the electronic components, so as to enable the electronic components inside the host device to operate normally in an environment without external interference.

In the casing structure, the casing must be formed with an opening for the assembly of the electronic components therein. The opening is overlapped with a panel to maintain the complete look of the casing structure. In the prior art, the panel is fixedly fastened to the casing by screws to ensure the panel not falling off from the casing. However, the fasten and loosen processes of general screws or thumb screws are troublesome, and the efficiency in removing and attaching the panel is low.

In addition, because of an assembly tolerance between the casing and the panel or the casing deformation caused by an external force, a tight fit combination is usually formed between the casing and the panel. Although such tight fit bonding will not affect the use of the casing structure, it always causes difficulties in lifting the panel when the panel needs to be removed. Therefore, a tool, for example, a screw driver, is used to insert into the slit between the panel and the casing to lift the panel, which causes inconvenience in the subsequent maintenance of the host device. In addition, the use of the tool in lift the panel may damage the casing and the panel and even cause deformations of the casing.

### SUMMARY OF THE INVENTION

In view of the above problems, the present invention provides a buckling assembly and a casing structure using the same. The buckling assembly enables a quick attachment and removal of a panel of the casing structure, so as to solve the deficiency that the efficiency in removing and attaching the panel is low in the prior art.

The buckling assembly of the present invention, which is applicable to a casing structure for integrating a panel and the casing. The buckling assembly is mounted on an inner side of the casing or the panel, for locking a buckled member. When the buckling assembly is disposed in the casing, the buckled member may be the panel or an independent component disposed on the panel. When the buckling assembly is disposed on the panel, the buckled member may be a part of the casing or an independent component disposed in the casing. The buckling assembly includes a guide rail, a locking seat, and a rotary handle. The guide rail is fixed on an inner side of the casing or the panel. The locking seat is slidably disposed on the guide rail, for fixedly locking the buckling assembly. The rotary handle is pivotally affixed to the guide rail and may be turned to drive the locking seat move on the guide rail, so as to lock or release the buckled member.

The buckled member may be further formed with a locking hole, and the locking seat is provided with a hook that inserts into the locking hole, such that the locking seat locks the buckled member. The hook may further be formed with a slanted urging edge at its one side, and the slanted urging edge is at an inclined angle from a moving direction of the locking seat. When releasing, the slanted urging edge presses against one end of the locking hole to push the buckling assembly away from the buckled member, so as to facilitate the opening of the panel.

The advantage of the present invention lies in that, the buckling assembly may quickly lock or release the buckled member, which omits the complex processes of fastening and loosening screws. Meanwhile, the hook may push the buckling assembly away from the buckled member to effectively solve the problem that the panel is difficult to be lifted due to tight fit between the panel and the casing in the prior art.

### BRIEF DESCRIPTION OF THE DRAWINGS

The present invention will become more fully understood from the detailed description given herein below for illustration only, and thus are not limitative of the present invention, and wherein:

FIG. 1A is an exploded view of a casing structure according to a first embodiment of the present invention;

FIG. 1B is a perspective view of the casing structure according to the first embodiment of the present invention;

FIG. 2 is an exploded view of a buckling assembly according to the first embodiment of the present invention;

FIGS. 3A and 3B are side views of the buckling assembly according to the first embodiment of the present invention;

FIG. 4 is a partial cross-sectional view of a hook and a panel according to the first embodiment of the present invention;

FIG. 5 is a perspective view of the panel when combined with the casing according to the first embodiment of the present invention;

FIGS. 6 and 7 are partial cross-sectional views of the hook and the panel according to the first embodiment of the present invention, illustrating a process of the hook inserting into a locking hole;

FIGS. 8 and 9 are partial cross-sectional views of the hook and the panel according to the first embodiment of the present invention, illustrating a process of the hook disengaging from the locking hole; and

FIG. 10 is an exploded view of a second embodiment of the present invention.

### DETAILED DESCRIPTION OF THE INVENTION

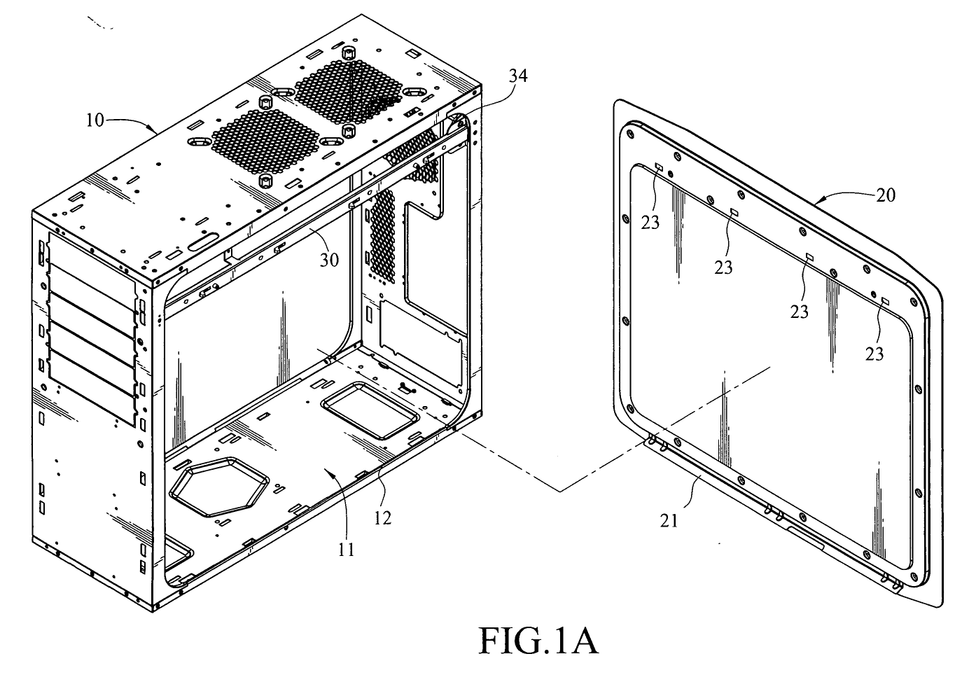

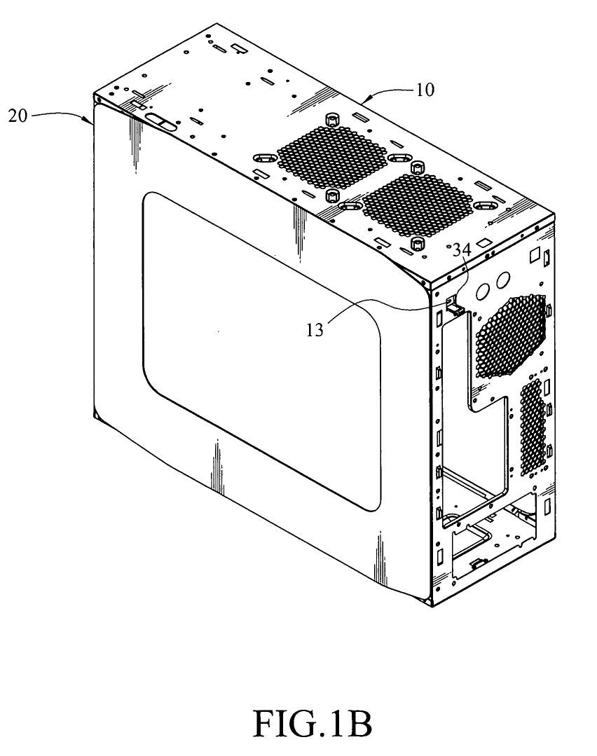

Please refer to FIGS. 1A and 1B, the buckling assembly 30 in a first embodiment of the present invention is applied in a casing structure having a casing 10 and a panel 20. The buckling assembly 30 is used for locking a buckled member. When the buckling assembly 30 is disposed in the casing 10, the buckled member may be the panel 20 or an independent component disposed on the panel 20. When the buckling assembly 30 is disposed on the panel 20, the buckled member may be the casing 10 or an independent component disposed in the casing 10. In the first embodiment, the buckling assembly 30 is disposed in the casing 10, and the buckled member is the panel 20. The casing 10 has an opening 11 on its one side. The panel 20 is used for covering the opening 11. The buckling assembly 30 is used for fixing the panel 20 to the casing 10, such that the panel 20 seals the opening 11 and will not fall off from the casing 10.

Referring to FIGS. 1A and 1B, the casing 10 has a flange 12 therein, and the flange 12 is formed on a bottom side edge of the opening 11. The panel 20 has a clamping folded edge 21 and a plurality of locking holes 23 on an inner side of the panel 20. The clamping folded edge 21 corresponds to a side edge of the panel 20, for clamping the flange 12 of the casing 10. Thus, the side edge of the panel 20 is combined with the bottom side edge of the opening 11 of the casing 10. The locking holes 23 are formed on the inner side of the panel 20 and face the interior of the casing 10 when the panel 20 covers the opening 11, so as to be combined with the buckling assembly 30. Another side edge of the panel 20 is combined with a top edge of the opening 11. In addition, the casing 10 further has a perforation 13 opened on a back panel of the casing 10 for communicating the inside and outside of the casing 10.

Please refer to FIGS. 1A, 1B, 2, 3A, and 3B, the buckling assembly 30 includes a guide rail 31, a locking seat 32, a latch 33, and a rotary handle 34.

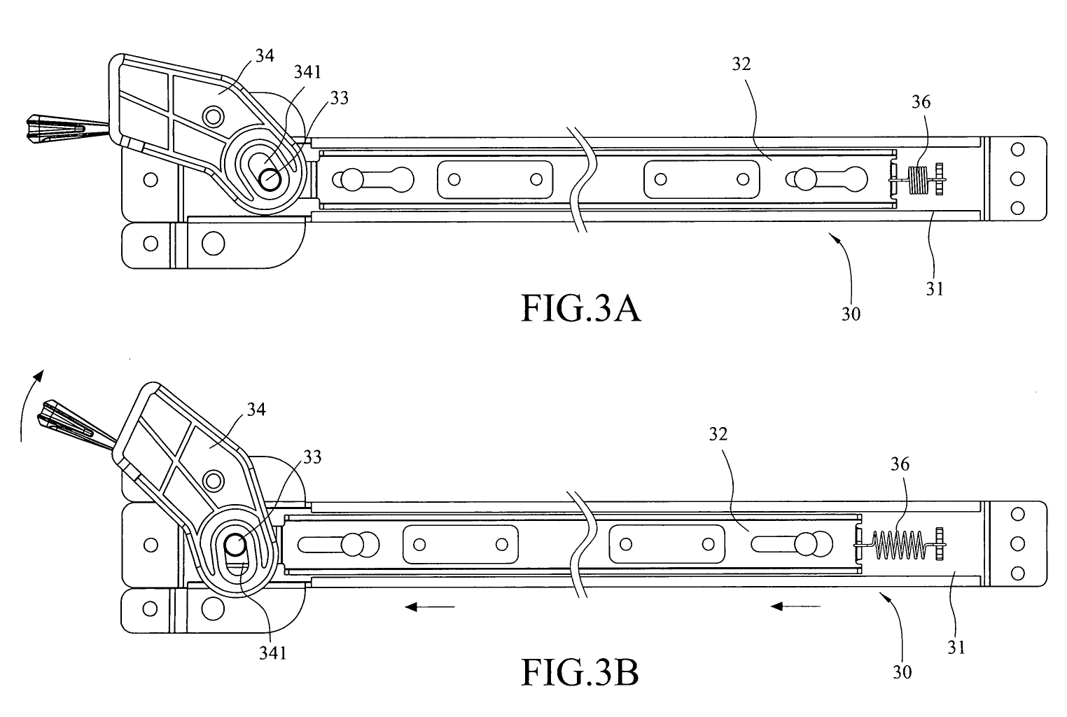

Referring to FIGS. 1A, 1B, 3A, and 3B, the guide rail 31 is disposed in the casing 10, corresponding in parallel to a top edge of the opening 11. One end of the guide rail 31 extends towards the perforation 13 of the back panel.

As shown in FIGS. 1A, 1B, 2, 3A, and 3B, the locking seat 32 is slidably disposed on and guided by the guide rail 31. That is to say, through the connection of the guide rail 31, the locking seat 32 is movable between a locking and releasing position in a direction parallel to the top edge of the opening 11.

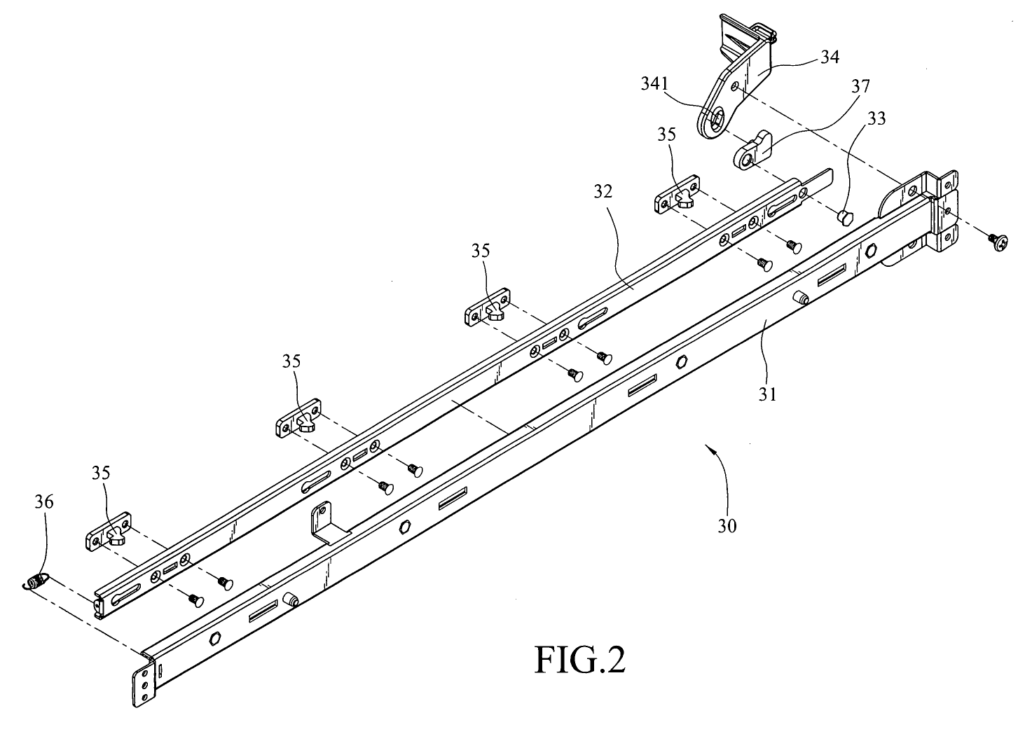

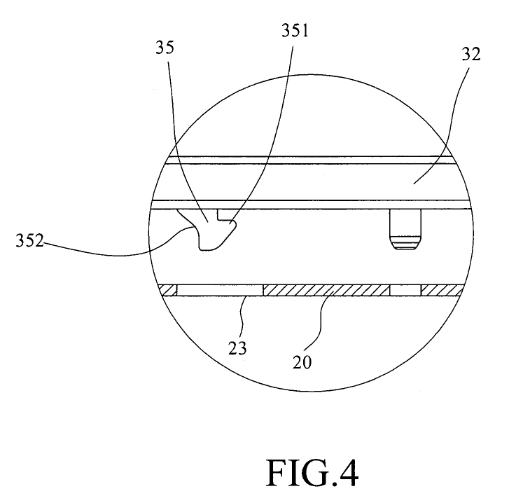

Referring to FIGS. 2, 3A, 3B, and 4, the locking seat 32 has a plurality of hooks 35, for locking the locking holes 23 to fix the panel 20 when the locking seat 32 is in the locking position. The hooks 35 may be integrally formed on the locking seat 32 or independent components fixed on the locking seat 32 after fabrication. Each of the hooks 35 has a locking portion 351 and a slanted urging edge 352. The locking portion 351 is located at one side of the hook 35 and protrudes outwards. When the locking seat 32 is displaced to the locking position, the locking portion 351 may lock one end of the locking hole 23. The slanted urging edge 352 is located at the other side of the hook 35 and is formed at an inclined angle from a moving direction of the locking seat 32. When the locking seat moves towards the releasing position, the slanted urging edge 352 may press against the other end of the locking hole 23 to make it slide on the slanted urging edge 352, thereby pushing the panel 20 away from the casing 10. That is to say, besides fixing the panel 20 when in the locking position, the panel 20 may be pushed away when the locking seat 32 moves towards the releasing position, such that the side edge of the panel 20 corresponding to the top edge of the opening 11 is disengaged from the casing 10. The locking seat 32 is connected to the guide rail 31 by an elastic component 36, so as to be kept in the locking position by the elastic force, and thus the locking seat 32 will not produce displacement when the casing structure vibrates under an external force.

Referring to FIGS. 2, 3A, and 3B, the rotary handle 34 is pivotally affixed to the guide rail 31 and protrudes out of the casing 10 through the perforation 13 (as shown in FIG. 1B). The rotary handle 34 has an arc sliding slot 341. The latch 33 is fixed at one end to the locking seat 32, and passes through and slides in the arc sliding slot 341. When the rotary handle 34 is turned, the latch 33 slides in the arc sliding slot 341 to drive the locking seat 32 move to-and-fro on the guide rail 31 straightly along a horizontal direction (parallel to the top edge of the opening 11) between the locking position and the releasing position. The locking seat 32 is further provided with a connection piece 37 and the latch 33 passes through the connection piece 37. The connection piece 37 is placed between the locking seat 32 and the rotary handle 34, thereby filling the gap therebetween caused by their arrangement positions, and meanwhile preventing the locking seat 32 being in direct contact with the rotary handle 34, so as to avoid a large frictional resistance caused by the differences in the materials of the locking seat 32 and the rotary handle 34.

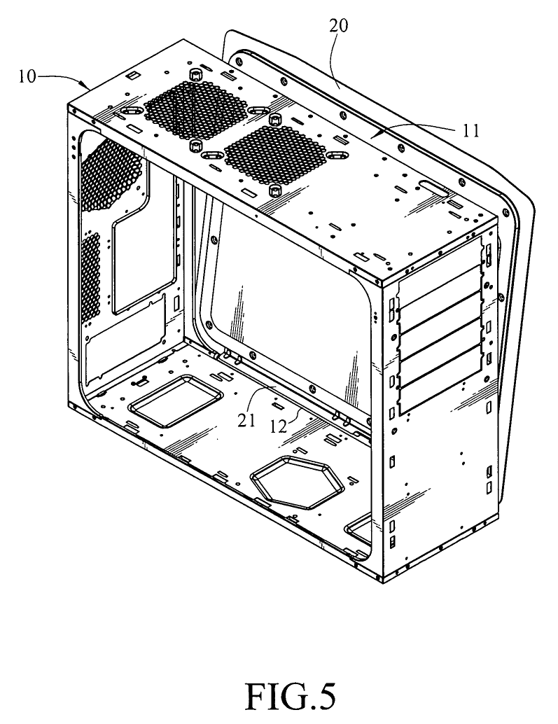

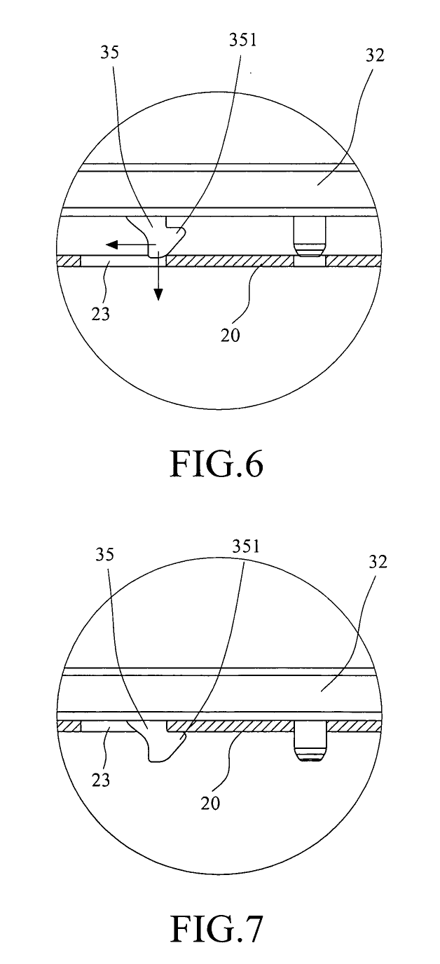

Referring to FIGS. 5, 6, and 7, the processes of the panel 20 being covered on the opening 11 are shown. First, the clamping folded edge 21 of the panel 20 clamps the flange 12 of the casing 10 to fix one side edge of the panel 20. Then, another side edge of the panel 20 is pushed towards the casing 10 to make the hooks 35 contacts the locking holes 23. After contacting the locking holes 23, the hooks 35 will push the locking seat 32 to displace to the releasing position from the locking position, so that the hooks 35 insert into the locking holes 23. After that, the elastic component 36 (depicted in the FIGS. 3A and 3B) will push the locking seat 32 back to the locking position, so that the locking portion 351 hooks one end of the locking hole 23. In this way, the panel 20 may be fixed to the casing 10.

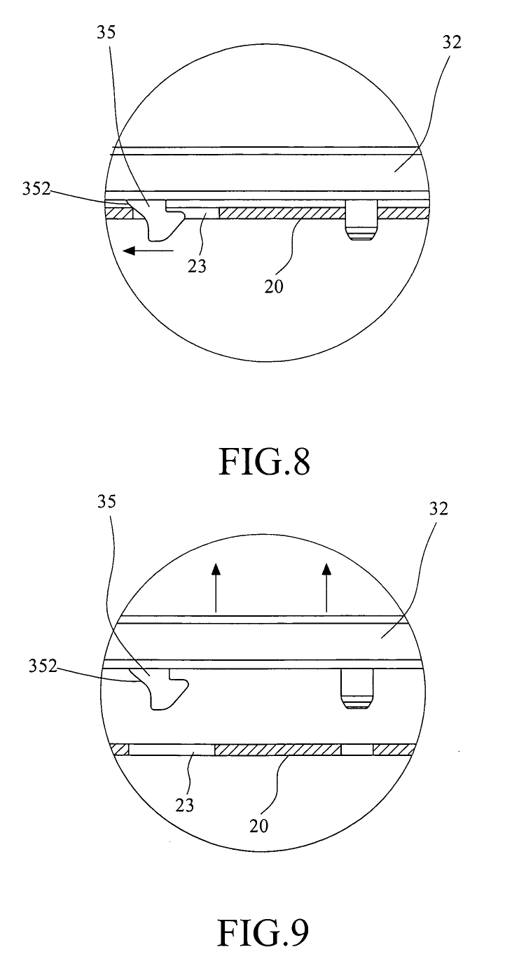

Referring to FIGS. 5, 8, and 9, the processes of removing the panel 20 from the casing 10 are shown. When removing the panel 20, the rotary handle 34 is first turned to drive the locking seat 32 move from the locking position to the releasing position (see FIG. 3B). During this process, the slanted urging edge 352 of the hook 35 contacts another end of the locking hole 23 and pushes the panel 20 outwardly, such that the portion of the panel 20 combined with the top edge of the opening 11 disengages from the casing 10 so as to facilitate the user to grab the panel 20. Then, the panel 20 may be completely removed by pulling up the panel 20 to make the clamping folded edge 21 disengages from the flange 12.

In the casing structure of the present invention, the attachment and removal of the panel 20 can be quickly completed without using a tool. When fixing the panel 20, the panel 20 only needs to be pushed towards a predetermined position according to the combination processes, such that the hooks 35 insert into the locking holes 23 to fix the panel 20. When removing the panel 20, the rotary handle 34 only needs to be turned to release and push the panel 20 away from the casing 10, thereby solving the problem that the panel is often difficult to be lifted from the casing in the prior art.

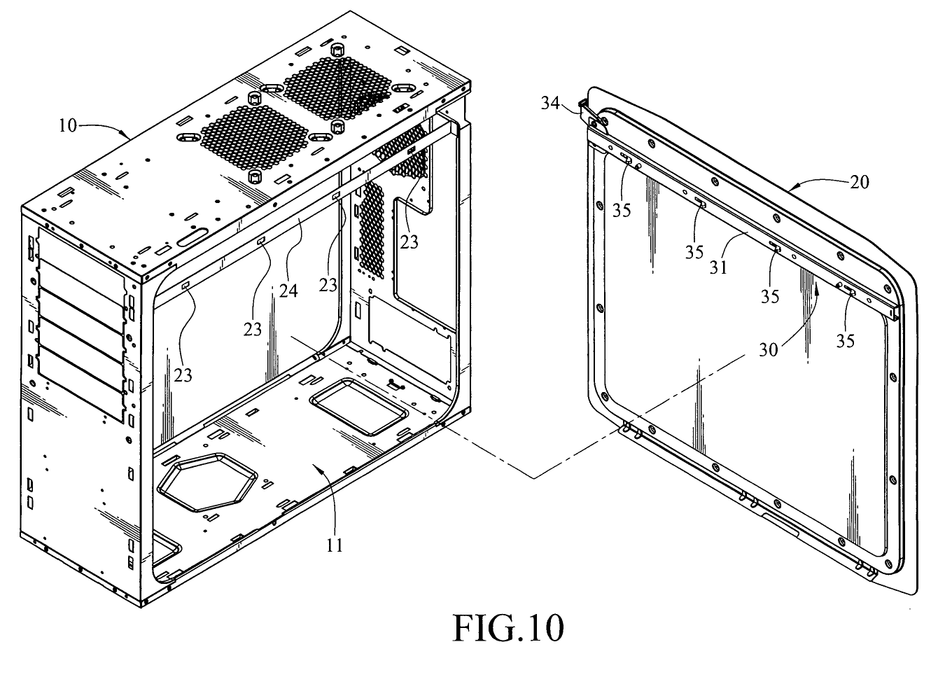

Referring to FIG. 10, the casing structure according to a second embodiment of the present invention is shown. The buckling assembly 30 is disposed on the inner side of the panel 20, and the casing 10 is regarded as the buckled member. Also, a fixing plate 24 is disposed in the casing 10 to be combined with the buckling assembly 30, and the casing 10 becomes the buckled member. Obviously, the fixing plate 24 may also be a part of the casing 10. In addition, a plurality of locking holes 23 is formed on the fixing plate 24 of the casing 10. The buckling assembly 30 is approximately the same as that of the first embodiment and includes the locking seat, the pin, the rotary handle 34, the connection piece, the spring, etc., and the same connection relationship is the same as that of the first embodiment. The difference therebetween resides in that, in the second embodiment, the guide rail 31 is disposed on the panel 20, and the locking seat is slidably disposed and has a plurality of hooks 35. The rotary handle 34 may be turned to drive the locking seat move between the locking position and releasing position. When the locking seat is in the locking position, the hooks 35 may lock the locking holes 23 in the casing 10 to fix the panel 20. Or, when the locking seat is in the releasing position, the slanted urging edges of the hooks 23 may press against the ends of the locking holes 23 to push the panel 20 away from the casing 10.

What is claimed is:

1. A buckling assembly for locking a buckled member, the buckling assembly comprises:
a guide rail;
a locking seat, slidably disposed on the guide rail, wherein the buckled member is disposed on one side of the locking seat and capable of being fixedly locked by the locking seat; and
a rotary handle, pivotally affixed to the guide rail and turned to drive the locking seat move on the guide rail.

2. The buckling assembly according to claim 1, wherein the locking seat has at least one hook engaging at least one locking hole of the buckled member.

3. The buckling assembly according to claim 2, wherein the hook has a locking portion at its one side.

4. The buckling assembly according to claim 3, wherein the hook has a slanted urging edge at its other side, and the slanted urging edge is formed at an inclined angle from a moving direction of the locking seat.

5. The buckling assembly according to claim 1, further comprising a latch with one end fixed to the locking seat, and the rotary handle has an arc sliding slot, wherein the rotary handle is turned to make the latch slide in the arc sliding slot so as to drive the locking seat.

6. The buckling assembly according to claim 5, further comprising a connection piece disposed on the locking seat, and the latch passes through the connection piece.

7. The buckling assembly according to claim 1, further comprising an elastic component that connects the guide rail and the locking seat.

8. The buckling assembly according to claim 1, wherein the buckled member is a casing.

9. The buckling assembly according to claim 1, wherein the buckled member is a panel.

10. A casing structure, comprising:
a casing, having an opening on its one side;
a panel, for covering the opening of the casing; and
a buckling assembly, disposed in the casing, comprising:
a guide rail, disposed in the casing;
a locking seat, slidably disposed on the guide rail to lock the panel; and
a rotary handle, pivotally affixed to the guide rail and turned to drive the locking seat move on the guide rail.

11. The casing structure according to claim 10, wherein the panel further has at least one locking hole formed on an inner side thereof, and the locking seat has at least one hook inserting into the locking hole.

12. The casing structure according to claim 11, wherein the locking seat is movable between a locking position and a releasing position, and when the locking seat is in the locking position, the hook locks one end of the locking hole to fix the panel.

13. The casing structure according to claim 12, wherein the hook has a locking portion at its one side, and the locking portion is used for locking the end of the locking hole when the locking seat is in the locking position.

14. The casing structure according to claim 13, wherein the hook has a slanted urging edge at its other side, and the slanted urging edge is used for pressing against another end of the locking hole when the locking seat is in the releasing position, so as to push the panel away from the casing.

15. The casing structure according to claim 10, further comprising a latch with one end fixed to the locking seat, and the rotary handle has an arc sliding slot, wherein the rotary handle is turned to make the latch slide in the arc sliding slot so as to drive the locking seat.

16. The casing structure according to claim 15, further comprising a connection piece disposed on the locking seat, and the latch passes through the connection piece.

17. The casing structure according to claim 10, wherein the casing has a perforation, and the rotary handle passes through the perforation to protrude out of the casing.

18. The casing structure according to claim 10, further comprising a spring that connects the guide rail and the locking seat.

19. A casing structure, comprising:
a casing, having an opening;
a panel, for covering the opening of the casing; and
a buckling assembly, disposed on the panel, comprising:
a guide rail, disposed on the panel;
a locking seat, slidably disposed on the guide rail to lock the casing; and
a rotary handle, pivotally affixed to the guide rail and turned to drive the locking seat move on the guide rail.

20. The casing structure according to claim 19, wherein the casing further has at least one locking hole, and the locking seat has at least one hook inserting into the locking hole.

21. The casing structure according to claim 20, wherein the locking seat is movable between a locking position and releasing position, and when the locking seat is in the locking position, the hook locks one end of the locking hole to fix the panel.

22. The casing structure according to claim 21, wherein the hook has a locking portion at its one side, and the locking portion is used for locking the end of the locking hole when the locking seat is in the locking position.

23. The casing structure according to claim 22, wherein the hook has a slanted urging edge at its other side, and the slanted urging edge is used for pressing against another end of the locking hole when the locking seat is in the releasing position, so as to push the panel away from the casing.

24. The casing structure according to claim 20, wherein the casing has a fixing plate, and the locking hole is formed on the fixing plate.

25. The casing structure according to claim 19, further comprising a latch with one end fixed to the locking seat, and the rotary handle has an arc sliding slot, wherein the rotary handle is turned to make the latch slide in the arc sliding slot so as to drive the locking seat.

26. The casing structure according to claim 25, further comprising a connection piece disposed on the locking seat, and the latch passes through the connection piece.

27. The casing structure according to claim 19, further comprising a spring that connects the guide rail and the locking seat.
